(19) United States
(12) Patent Application Publication
(10) Pub. No.: US 2007/0171061 A1
(43) Pub. Date: Jul. 26, 2007

(54) Theft deterrent device with dual sensor assembly

(75) Inventors: Dennis D. Belden, Canton, OH (US); Ronald M. Marsilio, Lake Wiley, SC (US)

Correspondence Address: SAND & SEBOLT, AEGIS TOWER, SUITE 1100, 4940 MUNSON STREET, NW, CANTON, OH, 44718-3615, US

(73) Assignee: ALPHA SECURITY PRODUCTS, INC., Charlotte, NC (US)

(21) Appl. No.: 11/653,565

(22) Filed: Jan. 16, 2007

Related U.S. Application Data
(63) Continuation-in-part of application No. 11/331,528, filed on Jan. 13, 2006.

(51) Int. Cl. G08B 13/14

(52) U.S. Cl. 340/568.2

(57) ABSTRACT

A theft deterrent device allows a customer to handle an item of merchandise to which the device is connected. The device is configured to protect items of merchandise having first and second pieces each of which are sufficiently valuable to warrant such protection. The device includes a base mountable on a support structure, an audible alarm, first and second connectors which attach respectively to the first and second pieces of the item of merchandise, lanyards for connecting the base to the first and second connectors and a removal sensor for sensing removal of one or both of connectors from the first and second pieces of the item of merchandise so that the alarm is activated when the connector or connectors are removed from the item of merchandise. The lanyards provide electrical communication between the alarm and the connectors, which may include plunger switches which serve as removal sensors.

### CROSS REFERENCE TO RELATED APPLICATION

This application is a continuation-in-part of U.S. patent application Ser. No. 11/331,528, filed Jan. 13, 2006; the disclosure of which is incorporated herein by reference.

### BACKGROUND OF THE INVENTION

1. Technical Field

The present invention relates generally to theft deterrent devices for retail establishments. More particularly, the invention relates to a security device which attaches to an item of merchandise. Specifically, the invention relates to such a security device which attaches to an item of merchandise which having two pieces each of which are protected by the security device.

2. Background Information

Retail stores have had a difficult time in protecting items of merchandise which the potential customer wishes to visually inspect and handle prior to making the decision to purchase the item. Often, such items of merchandise have been kept in a glass case under lock and key, which does not allow the customer to handle the item without the assistance of store personnel. In addition, while such items may be secured to a foundation or base by a cable or the like, this does not necessarily prevent the theft of the item by the cutting of the cable. Thus, there is a need in the art for security devices which allow for the handling of the item and which will alarm should someone try to steal the item. Certain items of merchandise have two pieces which are removably connected to one another and each of which are sufficiently valuable for the retailer to desire protection against theft of either piece of the merchandise.

### BRIEF SUMMARY OF THE INVENTION

The present invention provides a theft deterrent device comprising a base adapted to mount on a support structure; an audible alarm; a first connector movable between attached and removed positions; wherein the first connector is adapted to attach to a first piece of an item of merchandise in the attached position and be removed therefrom in the removed position; a second connector movable between attached and removed positions; wherein the second connector is adapted to attach to a second piece of the item of merchandise in its attached position and be removed therefrom in its removed position; at least one lanyard for connecting the base to each of the first and second connectors; at least one removal sensor for sensing movement of at least one of the first and second connectors from its respective attached position to its respective removed position; wherein the alarm is activated when the at least one connector moves from its respective attached position to its respective removed position.

The present invention further provides a security device comprising a base adapted to mount on a support structure; an audible alarm; a first connector movable between attached and removed positions; wherein the first connector is adapted to attach to a first piece of an item of merchandise in the attached position and be removed therefrom in the removed position; a second connector movable between attached and removed positions; wherein the second connector is adapted to attach to a second piece of the item of merchandise in its attached position and be removed therefrom in its removed position; at least one lanyard which provides electrical communication between the alarm and each of the first and second connectors; wherein movement of one of the first and second connectors from its respective attached position to its respective removed position activates the alarm.

The present invention furthermore provides a security device wherein the first sensor is attached to a first piece of the item of merchandise and base containing an audible alarm by a first lanyard with a second sensor being attached to a second piece of the item of merchandise and removably attached to the first sensor by a second lanyard enabling it to be readily removed from the second piece of merchandise when not required, and which is electrically connected to the alarm independent of the first sensor wherein both of the sensors are unaffected by the operation of the other of said sensors, yet which enables the two pieces of the item of merchandise to be protected by the remotely located alarm.

### BRIEF DESCRIPTION OF THE SEVERAL VIEWS OF THE DRAWINGS

FIG. 1 is a side elevational view of a first embodiment of the present invention attached to a battery powered drill.

FIG. 2 is a perspective view of the lanyard assembly of the first embodiment.

FIG. 3 is an exploded perspective view of a portion of the lanyard assembly showing the first connector disassembled.

FIG. 4 is a bottom plan view of first connector of the first embodiment with the bottom wall removed.

FIG. 5 is a sectional view of the first connector of the first embodiment taken from the side.

FIG. 6 is a side elevational view of a second embodiment of the lanyard assembly of the present invention with portions cut away.

FIG. 7 is a bottom plan view similar to FIG. 4 showing the first connector of the second embodiment.

FIG. 8 is a sectional view similar to FIG. 5 of the first connector of the second embodiment.

FIG. 9 is a side elevational view similar to FIG. 6 showing a third embodiment of the lanyard assembly of the present invention.

FIG. 10 is a bottom view similar to FIGS. 4 and 7 showing the connector of the third embodiment.

FIG. 11 is a sectional view similar to FIGS. 5 and 8 of the connector of the third embodiment.

FIG. 12 is a side elevational view of a further embodiment of the present invention attached to the same battery powered drill as that of FIG. 1.

FIG. 13 is a fragmentary view, portions of which are in section, of the lanyard assembly for connecting the pair of sensors to a remote alarm.

FIG. 14 is a fragmentary view, portions of which are in section, of the lanyard assembly shown in FIG. 13.

FIG. 15 is a fragmentary view, portions of which are in section, of a modified form of the lanyard assembly shown in FIGS. 13 and 14.

Similar numbers refer to similar parts throughout the drawings.

### DETAILED DESCRIPTION OF THE INVENTION

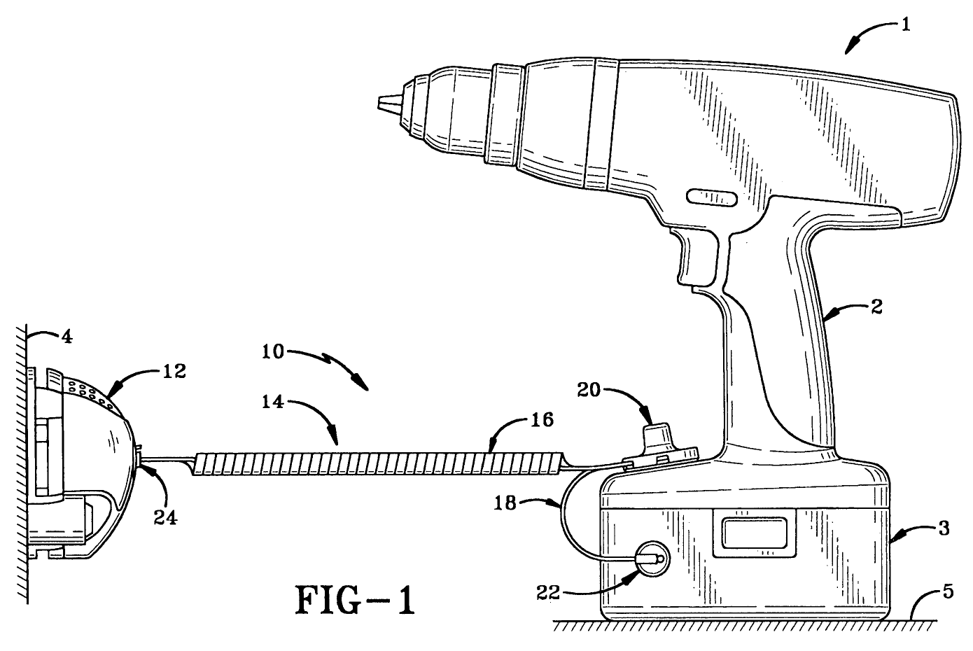

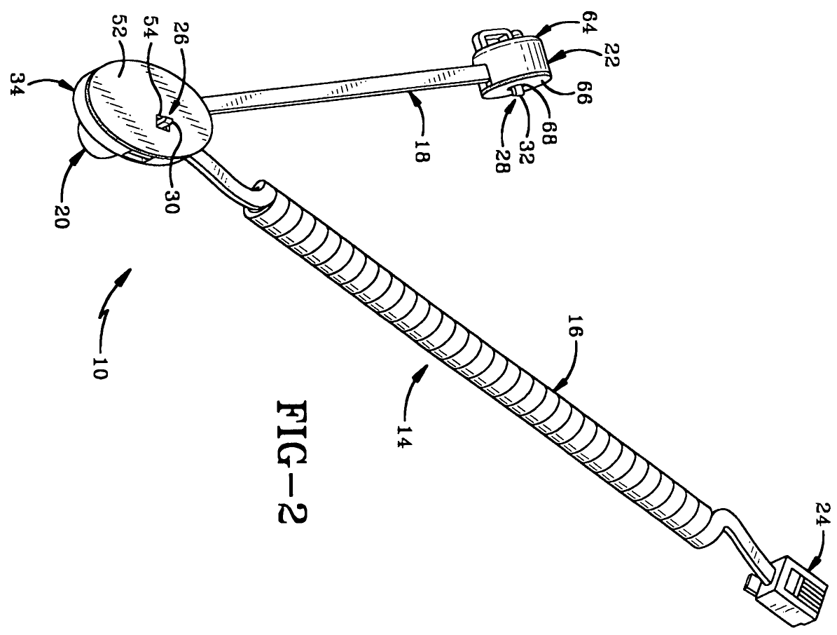

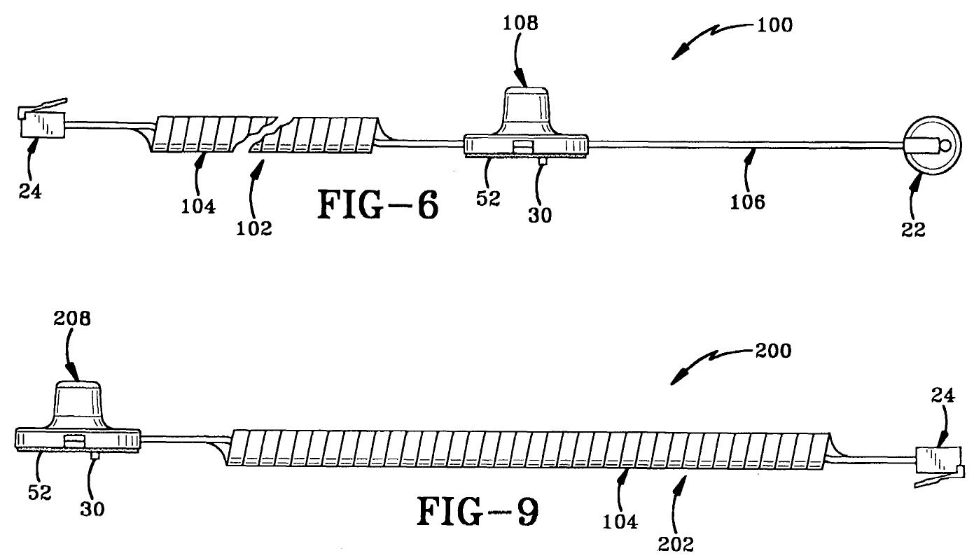

A first embodiment of the security device of the present invention is indicated generally at 10 in FIGS. 1 and 2; a second embodiment is indicated generally at 100 in FIG. 6; and the third embodiment is indicated generally at 200 in FIG. 9. Referring to FIG. 1, device 10 is shown mounted on an item of merchandise 1 in the form of a battery powered drill which has first and second pieces 2 and 3. First piece 2 is more particularly the drill body and second piece 3 is the rechargeable battery which provides power to body 2 in order to operate drill 1. First and second pieces 2 and 3 are removably connected to one another and are sufficiently valuable to make it desirable to protect each piece 2 and 3 from theft. Device 10 is configured to set off an alarm should the theft of either piece 2 and 3 be attempted.

Device 10 includes an alarming station or member 12 which is securely mounted on a wall or other support structure 4. Alarming member 12 is described in co-pending provisional patent application having Ser. No. 60/644,206, the contents of which are incorporated herein by reference. Item 1 of merchandise is seated on a display surface 5. A lanyard assembly 14 is connected to each of alarm member 12 and item 1 of merchandise.

With reference to FIGS. 1 and 2, lanyard assembly 14 includes first and second lanyards 16 and 18 and first and second connectors 20 and 22. First lanyard 16 is in the form of an alarming cable which is connected to alarm member 12 via a removable plug 24 and to first connector 20, which is shown attached in FIG. 1 to first piece 2 of item 1 of merchandise. Second lanyard 18 extends between and is connected to first and second connectors 20 and 22. Second connector 22 is shown in FIG. 1 attached to second piece 3 of item 1 of merchandise. In the exemplary embodiment, first and second connectors 20 and 22 are attached to first and second pieces 2 and 3 via an adhesive although other attachment mechanisms may be used. An adhesive connection provides a mechanism for preventing marring of the item of merchandise while allowing the item to be handled easily by the potential customer.

Referring to FIG. 2, first and second connectors 20 and 22 have respective removal sensors 26 and 28 in the form of plunger switches having respective first and second plungers 30 and 32 which are shown in an extended, non-depressed or removed position associated with being removed from item 1 of merchandise. When either one of plungers 30 and 32 are in the extended or removed position, alarm 12 will emit an audible alarm. However, alternate removal sensors may be utilized in place of plunger switches 26 and 28. Thus, device 10 is configured so that first and second connectors 20 and 22 attach to pieces 2 and 3 of item 1 of merchandise in a reasonably secure manner, but without being locked thereto. Thus, in the exemplary embodiment, there is no locking mechanism for locking device 10 to item 1 of merchandise and thus no key for the removal thereof. Thus, while connectors 20 and 22 may be pried off of item 1 of merchandise with some difficulty, the result is the sounding of the alarm of alarm member 12.

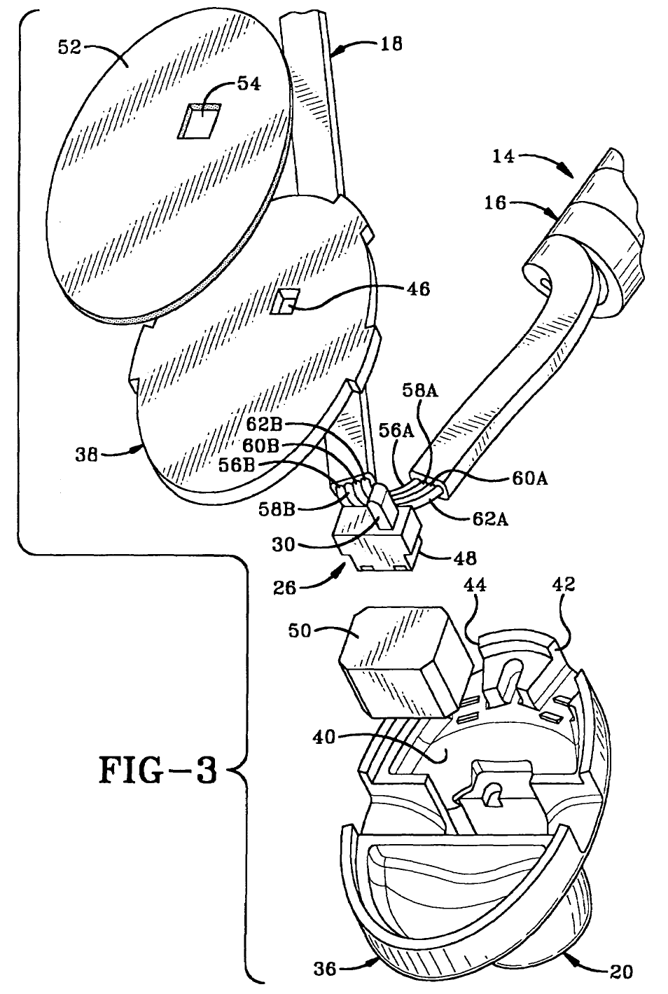

Referring to FIGS. 2 and 3, first connector 20 includes a housing 34 comprising first and second housing members 36 and 38. First housing member 36 defines an interior chamber 40 and first and second entrance openings 42 and 44 which communicate therewith. Second housing member 38 is in the form of a substantially flat oval-shaped bottom wall which is securely mounted to first housing member 36. Second housing member 38 defines an opening 46 for receiving plunger 30 of switch 26 therethrough. Interior chamber 40 of first housing member 36 is configured to receive a body 48 of switch 26 with portions of first and second lanyards 16 and 18 extending respectively through first and second entrance openings 42 and 44. Interior chamber 40 is also configured to receive other related structures such as structure 50 which may be for example, a magnet or an electronic article surveillance (EAS) tag. Use of an EAS tag may allow for the sounding of an alarm other than alarm member 12 should alarm member 12 somehow be nonfunctional. First connector 20 further includes a mounting mechanism in the form of an adhesive pad 52 which defines an opening 54 for receiving therethrough plunger 30 of switch 26. Second connector 22 likewise has a housing 64 and an adhesive pad 66 which defines an opening 68 for receiving therethrough plunger 32 of switch 28. Second connector 22 is thus adhered to second piece 3 of the item of merchandise via adhesive pads 66. As seen in FIGS. 3 and 4, entrance openings 42 and 44 are disposed adjacent one end of first housing member 36 so that first and second lanyards 16 and 18 extend generally from that end of housing member 36.

Alarming cable 16 includes four wires 56A, 58A, 60A and 62A. Second alarming cable 18 likewise includes four wires 56B, 58B, 60B and 62B which may or may not be continuous with wires 56A-62A of first cable 16. These wires provide respective electrical communication between plug 24 and each of switches 26 and 28 to form respective electrical circuits which are either open or closed when plungers 30 and 32 are respectively depressed.

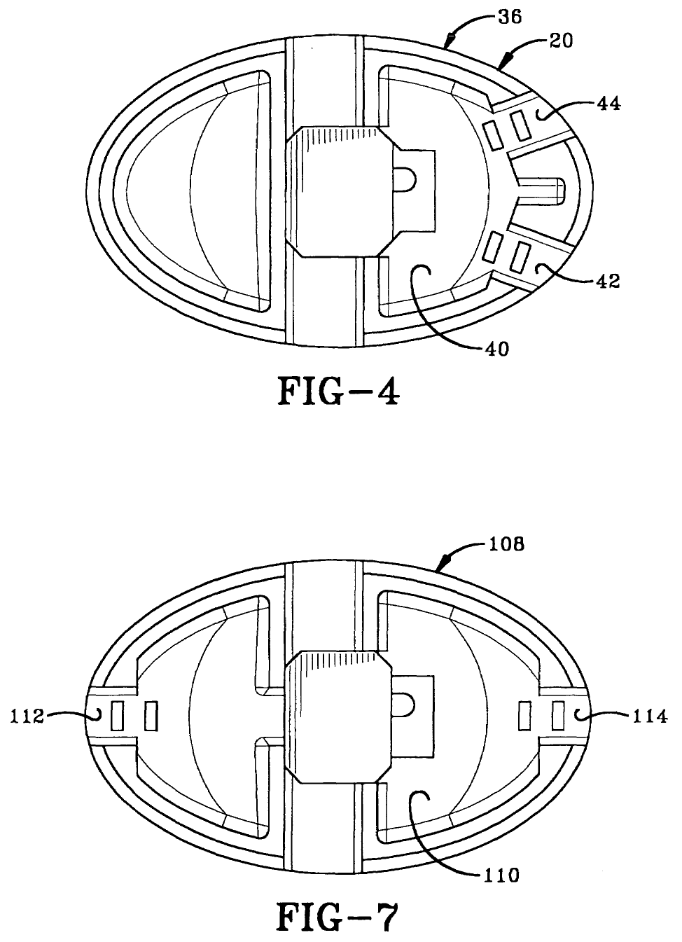

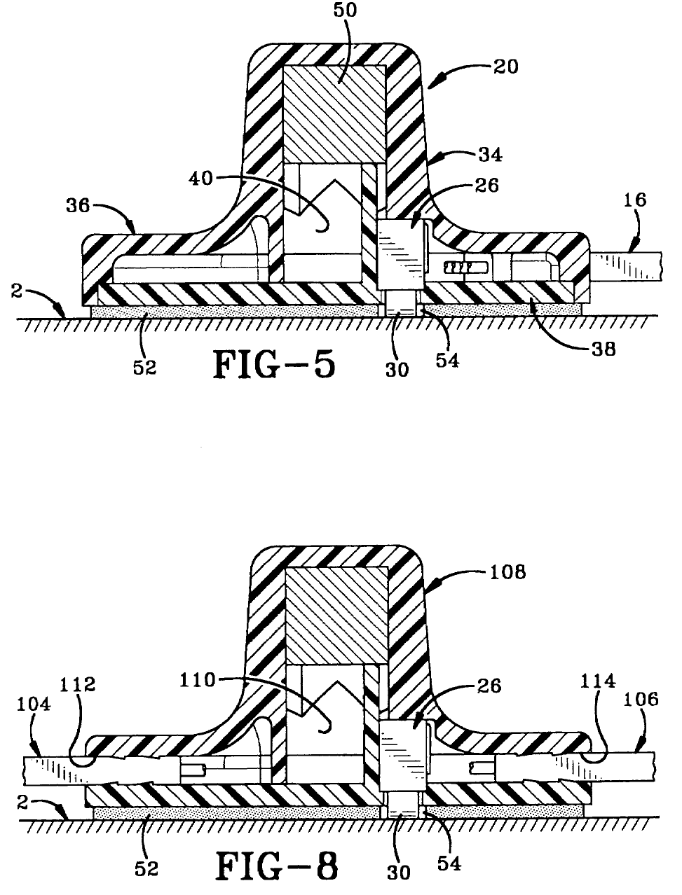

Device 10 is thus configured to sound an alarm of alarm member 12 if a potential thief attempts to steal either piece 2 and 3 of item 1 of merchandise by removing either of first and second connectors 20 and 22 from said pieces 2 and 3. More particularly, when plunger 30 of switch 26 is in a depressed position associated with the attached position of member 20 on first piece 2 of the article of merchandise (FIGS. 1 and 5), alarm member 12 will not sound an alarm. Second switch 28 of second connector 22 is likewise configured. Removal of either of first and second connectors 20 and 22 will respectively allow plunger 30 and 32 to extend and thus either open or close the respective electrical circuit which will cause alarm member 12 to sound an alarm. These circuits may be sense loops which if compromised cause the alarm of alarm member 12 to sound. For example, if plug 24 is removed from alarm member 12 or if one of lanyards 16 and 18 is severed, alarm member 12 will sound the alarm. In addition, as previously noted, should alarm member 12 somehow be nonfunctional, an EAS tag 50 or the like may allow for the sounding of an alarm should a connector 20 or 22 carrying such a tag remain attached to the item as it moves near or through a security gate. These various alarming characteristics and in particular used with a security gate are described in greater detail in co-pending patent application entitled Electronic Security Device and System for Article of Merchandise, filed on or about Dec. 20, 2005, the contents of which are incorporated herein by reference. Said application claims priority from provisional patent application having Ser. No. 60/639,770, filed on Dec. 28, 2004, the contents of which are also incorporated herein by reference.

With reference to FIGS. 6-8, security device 100 is described. Security device 100 is similar to security device 10 and operates in the same manner except that it has a lanyard assembly 102 which varies from lanyard assembly 14 of device 10. More particularly, lanyard assembly 102 includes first and second lanyards 104 and 106 which are similar to lanyards 16 and 18. In addition, assembly 102 includes a first connector 108 and second connector 22. The primary distinction between lanyard assembly 102 and lanyard assembly 14 is that assembly 102 allows for first and second lanyards 104 and 106 to extend from opposite ends of first connector 108. To that effect, first connector 108 defines an interior chamber 110 and first and second entrance openings 112 and 114 which communicate therewith and are formed on opposite ends of connector 108. First and second entrance openings 112 and 114 respectively receive portions of first and second lanyards 104 and 106 which are in electrical communication with switch 26 mounted within interior chamber 110. One skilled in the art will appreciate that the wiring configuration of lanyards 104 and 106 may vary as required in order to provide the electrical communication which provides the alarming characteristics described with respect to device 10.

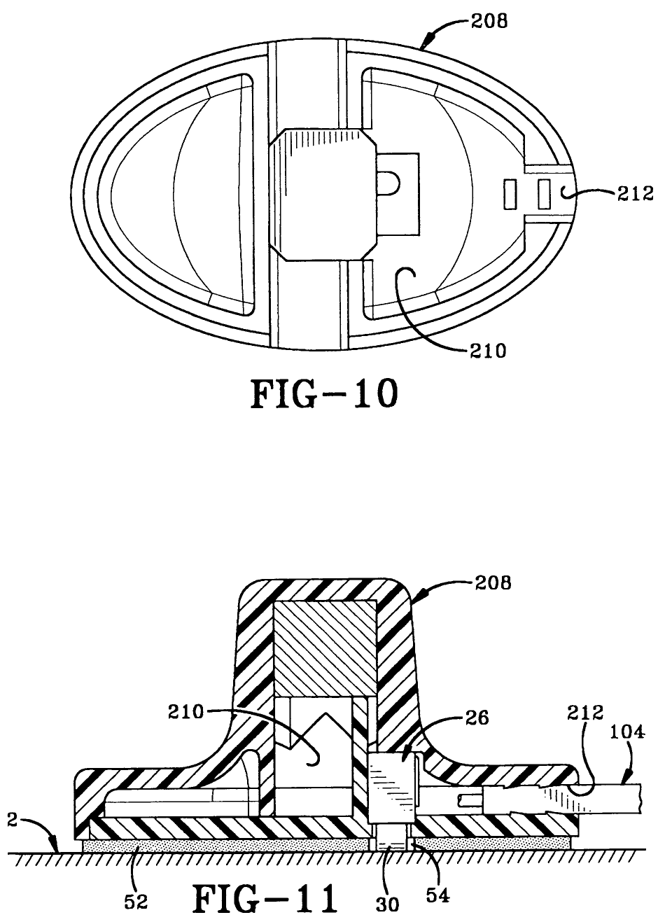

With reference to FIGS. 9-11, security device 200 is described. Device 200 is similar to devices 10 and 100 except that it utilizes a single connector for attaching to an item of merchandise. More particularly, device 200 includes a lanyard assembly 200 which utilizes a single lanyard 104 and a single connector 208. Connector 208 is similar to connectors 20 and 108 except for it defines an interior chamber 210 having a single entrance opening 212 for receiving therein a portion of lanyard 104 to provide electrical communication between switch 26 and plug 24. Security device 200 thus is configured to attach to an item of merchandise at one location instead of the two locations provided by the first and second connectors of devices 10 and 100. However, devices 200 similarly provides the removal sensor in the form of plunger switch 26 which provides for the sounding of alarm member 12 should connector 208 be removed from the item of merchandise.

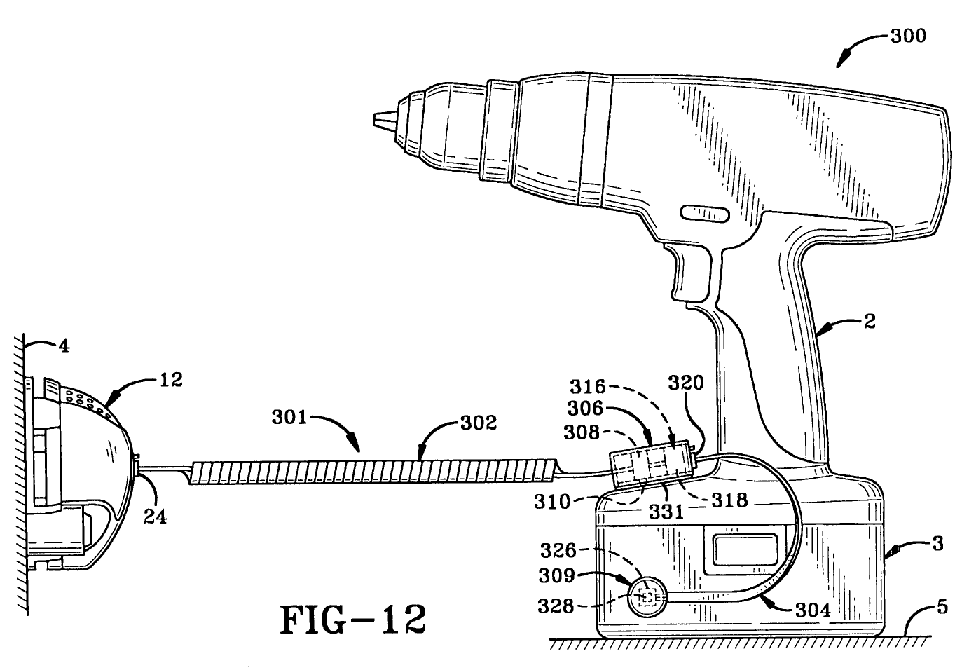

A further embodiment of the security device of the present invention is indicated generally at 300, and is shown particularly in FIGS. 12-15. Device 300 is similar to devices 10, 100 and 200 except that it utilizes a different lanyard assembly indicated generally at 301, which includes a first lanyard 302 and a second lanyard 304. First lanyard 302 is connected to alarming station or member 12 preferably by removable plug 24. The other end of lanyard 302 is connected to a first sensor 306. Sensor 306 includes an internal plunger switch 308 having a plunger 310 similar to that described above with respect to plungers 30 and 32. Plunger switch 308 is connected to alarm station 12 by a pair of conductors 312 and 312A which extend through lanyard 302. Lanyard 302 contains two additional conductors 314 and 314A which are connected to a connector indicated generally at 316 mounted within sensor 306. Connector 316 includes a jack 318 and a removable plug 320, with connectors 314 and 314A being hardwired to jack 318.

In accordance with one of the main features of this embodiment, plug 320 is removably connected to jack 318 as shown in FIGS. 13 and 14 by various means such as a spring biased lever 322. Electrical conductors 314 and 314A are electrically connected to two conductors 324 and 324A which extend through lanyard 304 at connector 316 and are electrically connected to a second plunger switch 326 mounted within a second sensor 309, which switch includes a plunger 328 associated therewith. As shown in FIG. 12, lanyard 302 extends from alarm 12 and is electrically and mechanically connected to sensor 306 and is actuated to sound an alarm should either of conductors 312 or 312A be severed or upon removal of sensor 306 from the item of merchandise by actuation of plunger 310. As discussed above with the earlier sensor embodiments, sensor 306 preferably is secured to the item of merchandise by a layer of pressure sensitive adhesive 331. Second sensor 309 also is removably attached to the second piece of the item of merchandise preferably by a layer of pressure sensitive adhesive 333. The alarm member 12 will also be actuated upon severing of one or both of the conductors 324 and 324A in second lanyard 304 or upon removal of sensor 309 from the second item of merchandise by movement of plunger 328. Furthermore, removal of plug 320 from its attachment to first sensor 306 by connector 316 will also cause alarm member 12 to be actuated by breaking of the conductor path formed by connected conductors 314-324 and 314A-324A which form a continuous loop from alarm member 12 through connector 316 and second sensor 309.

Lanyard assembly 301 enables first sensor 306 to be used with multiple types of products yet enables it to be used with other types of merchandise requiring a second sensor 309 which is easily removably attached to jack 318 of connector 316 in sensor 306. As shown in FIG. 13, the two electrical circuits, namely the first circuit consisting of conductors 312 and 312A which connect plunger switch 308 to member 12 is completely electrically distinct and independent from the second electrical circuit formed by conductors 314/314A and 324/324A which electrically connect plunger switch 326 of sensor 309 to alarm member 12. Thus, this provides versatility to the lanyard assembly and associated sensors by enabling sensor 306 to be used as a single sensor attached to a remote alarm or enable sensor 309 to be used as a second sensor attached to first sensor 306 by a readily removable type of connector consisting of a standard jack 318 and plug 320 which preferably is of the type commonly used for many current telephone connections.

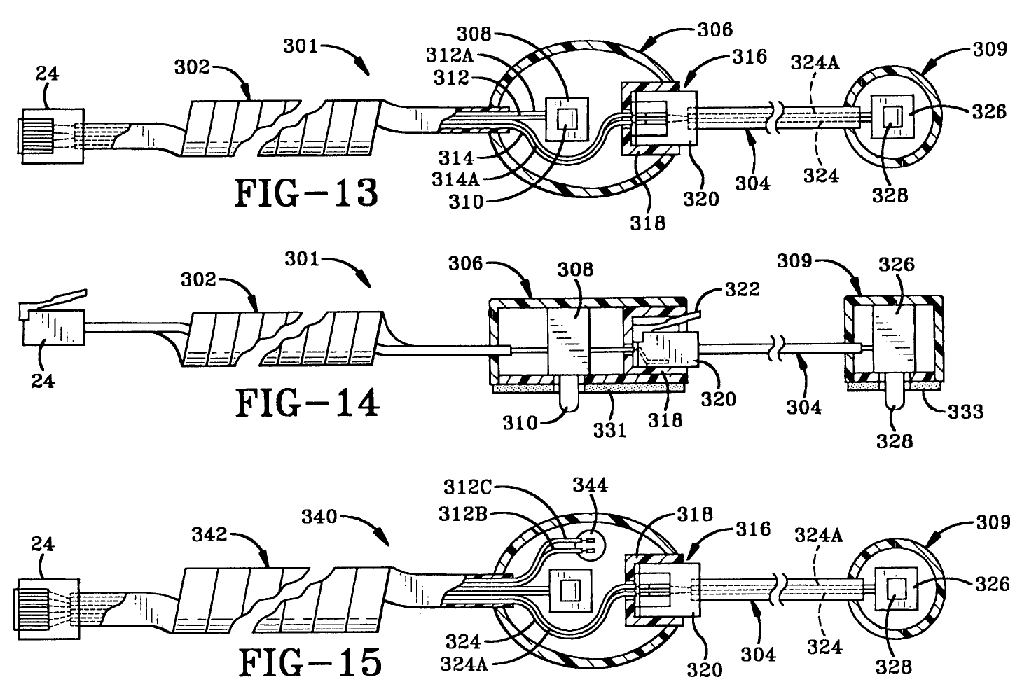

A further modified security device, and in particular, another lanyard assembly is indicated generally at 340 and is shown in FIG. 15. Lanyard assembly 340 is similar in many respects to lanyard assembly 301 discussed above and shown in FIGS. 13 and 14, with the main difference being that a first lanyard 342 includes two additional electrical conductors indicated at 312B and 312C in addition to the four conductors 312, 312A, 314 and 314A discussed above. Conductors 312B and 312C electrically connect a visual indicator such as a LED 344, to the appropriate circuitry contained in alarm member 12. The other two conductors 312 and 312A again connect to plunger switch 308 and may be electrically distinct or electrically connected through the appropriate circuitry and alarm module 312 to LED 344. However, conductors 324 and 324A of lanyard 304 are electrically connected to second sensor 309 as discussed above with respect to FIGS. 13 and 14, and are electrically distinct from the electrical conductors of lanyard 342 and the operation thereof which connect to plunger switch 308 and LED 344. Thus, the security device shown in FIGS. 12-15, and in particular the lanyard assembly thereof, provides greater versatility than that shown in the embodiments of FIGS. 1-11 by enabling second sensor 309 to be removably connected to first sensor 306 and enabling second sensor 309 to be operated electrically independent and distinct from sensor 306. This provides the merchant with greater flexibility in providing security to various types of products by providing a removably attached second sensor 309 requiring only the incorporation of a readily available and well-known connector jack 318 in first sensor 306. If desired, second sensor 309 could actually be connected to a second piece of merchandise completely independent from the single piece of merchandise as shown particularly in FIGS. 1 and 12 so long as the second piece of merchandise is closely located to the first item of merchandise. This avoids a second lanyard extending completely from the second item of merchandise to alarm member 12 by utilizing the removable connection to connector 316 of first sensor 306.

It is readily understood that the conductors of the various lanyard assemblies are connected to the appropriate circuitry located within alarm member 12, which circuitry is well-known to those skilled in the security alarm art, and thus is not described in detail.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A security device comprising:
a base adapted to mount on a support structure;
an audible alarm;
a first sensor movable between attached and removed positions, wherein the first sensor is adapted to attach to a first piece of an item of merchandise in the attached position and be removed therefrom in the removed position;
a second sensor movable between attached and removed positions, wherein the second sensor is adapted to attach to a second piece of the item of merchandise in the attached position and be removed therefrom in the removed position;
a first lanyard which provides electrical communication between the alarm and the first sensor wherein movement of the first sensor from its attached position to its removed position activates the alarm;
a second lanyard which provides electrical communication between the alarm and the second sensor wherein movement of the second sensor from its attached position to its removed position activates the alarm; and
a connector removably attaching the second sensor to the first sensor.

2. The security device defined in claim 1 wherein the first lanyard contains a plurality of electrical conductors electrically connecting the first sensor to the alarm.

3. The security device defined in claim 2 wherein the second lanyard contains a plurality of electrical conductors distinct from the conductors in the first lanyard electrically connecting the second sensor to the alarm.

4. The security device defined in claim 3 wherein the first sensor remains electrically connected to the alarm when the second lanyard is severed or the second sensor is moved to its removed position or the second lanyard is detached from the connector of the first sensor.

5. The security device defined in claim 1 wherein the second sensor remains electrically connected to the alarm when the first sensor is moved to its removed position.

6. The security device defined in claim 1 wherein the first lanyard contains four electrical conductors two of which are connected to the first sensor with the other two of said conductors continuing in the second lanyard to the second sensor.

7. The security device defined in claim 1 wherein the connector which removably attaches the second lanyard to the first sensor includes a manually operated plug attached to the second lanyard and a jack mounted in the first sensor for removably receiving the plug.

8. The security device defined in claim 7 wherein the connector plug includes a spring biased lever for removably connecting the plug to the jack in the first sensor.

9. The security device defined in claim 1 wherein the first sensor includes a plunger switch moveable between depressed and non-depressed positions associated respectively with the attached and removed positions of the first sensor.

10. The security device defined in claim 9 wherein the plunger switch is in electrical communication with the alarm via the first lanyard.

11. The security device defined in claim 1 wherein the alarm is actuated if at least either of the first and second lanyards are severed.

12. The security device defined in claim 1 wherein the first and second sensors each include an adhesive pad for attaching said sensors to the respective pieces of the item of merchandise.

13. The security device defined in claim 1 wherein the second lanyard mechanically connects the second sensor to the first sensor.

14. The security device defined in claim 1 wherein a visual indicator is provided on the first sensor.

15. The security device defined in claim 14 wherein the first lanyard contains six electrical conductors two of which are connected to a switch mounted in the first sensor with two other of said conductors being attached to the visual indicator in said first sensor.

16. A lanyard assembly for connecting a security system alarm to one or two items of merchandise comprising:
a first sensor movable between attached and removed positions, wherein the first sensor is adapted to attach to a first item in the attached position and be removed therefrom in the removed position;
a second sensor movable between attached and removed positions, wherein the second sensor is adapted to attach to a second item in the attached position and be removed therefrom in the removed position;
a first lanyard which provides electrical communication between the alarm and the first sensor wherein movement of the first sensor from its attached position to its removed position is adapted to activate the security system alarm;
a second lanyard which provides electrical communication between the alarm and the second sensor wherein movement of the second sensor from its attached position to its removed position is adapted to activate the security system alarm; and
a connector for removably attaching the second sensor to the first sensor.

17. The lanyard assembly defined in claim 16 wherein the first lanyard contains a plurality of electrical conductors adapted for electrically connecting the first sensor to the alarm; and in which the second lanyard contains a plurality of electrical conductors distinct from the first lanyard conductors adapted to electrically connect the second sensor to the alarm.

18. The lanyard assembly defined in claim 16 wherein the first lanyard contains four electrical conductors, two of which are connected to the first sensor with the other two of said conductors continuing in the second lanyard to the second sensor.

19. The lanyard assembly defined in claim 16 wherein the connector which removably attaches the second lanyard to the first sensor includes a manually operated plug attached to the second lanyard and a jack mounted in the first sensor for removably receiving the plug.

20. The lanyard assembly defined in claim 16 wherein the first lanyard contains six electrical conductors, two of which are connected to a switch mounted in the first sensor with two other of said conductors being attached to a visual indicator in said first sensor.
